(19) United States
(12) Patent Application Publication
(10) Pub. No.: US 2026/0319946 A1
(43) Pub. Date: Oct. 15, 2026

(54) DATA CACHING METHOD AND HOST SYSTEM

(71) Applicant: PHISON ELECTRONICS CORP., Miaoli (TW)

(72) Inventors: Chia Ming Hsu, Taichung City (TW); Yu Hsiang Chang, Tainan City (TW); Yi Jie Lee, Miaoli County (TW); Jian Ping Syu, Taichung City (TW); Hao-Zhi Lee, Miaoli (TW); An-Cheng Liu, Taipei City (TW)

(73) Assignee: PHISON ELECTRONICS CORP., Miaoli (TW)

(21) Appl. No.: 19/203,117

(22) Filed: May 8, 2025

(30) Foreign Application Priority Data
Apr. 9, 2025 (TW) 114113320

(51) Int. Cl. G06F 12/02

(52) U.S. Cl. CPC G06F 12/0246; G06F 2212/45

(57) ABSTRACT

This disclosure proposes a data caching method and a host system. The data caching method includes: inputting a plurality of tokens to a neural network, and obtaining key-value data corresponding to a plurality of layers; partitioning a first storage device into cache blocks and a shared block; storing first key-value data corresponding to all the layers to the cache blocks; storing second key-value data corresponding to a first layer of the layers to the shared block; storing the second key-value data in the key-value data and corresponding to at least one part of the other layers except for the first layer to a second storage device; and when performing an inference process with respect to the first layer, reading the first key-value data corresponding to the first layer from the cache blocks, and reading the second key-value data corresponding to the first layer from the shared block.

### CROSS-REFERENCE TO RELATED APPLICATION

This application claims the priority benefit of Taiwan application serial no. 114113320, filed on Apr. 9, 2025. The entirety of the above-mentioned patent application is hereby incorporated by reference herein and made a part of this specification.

### BACKGROUND

### Technical Field

The disclosure relates to a data caching method and a host system applied to key-value cache (KV cache).

### Description of Related Art

With the rapid development of artificial intelligence (AI) technology, especially in the field of natural language processing, large language models have been widely applied to various tasks, such as machine translation, conversation generation, and so on. These models typically adopt a self-attention mechanism to enhance the ability to process long texts. During the inference process, these models often need to perform the KV cache to avoid repetitive calculations and improve inference efficiency. The KV cache refers to temporarily storing keys and values generated for historical tokens in a memory, so that the stored keys and values can be quickly queried when subsequent tokens are generated, avoiding repetitive calculations. However, as the token length supported by the models increases, memory requirements for the KV cache also grow rapidly, and when the memory capacity is insufficient, the token length supported by the models is limited.

### SUMMARY

In order to solve the above problems, a data caching method and a host system are provided in the disclosure.

An exemplary embodiment of the disclosure provides a data caching method adapted to a first storage device and a second storage device. The data caching method includes: inputting a plurality of tokens to a neural network, and obtaining a plurality of key-value data corresponding to a plurality of layers; partitioning the first storage device into a cache blocks and at least one shared block; respectively storing first key-value data in the key-value data and corresponding to all the layers into the cache blocks corresponding to each of these layers; storing second key-value data in the key-value data and corresponding to a first layer of the layers into the at least one shared block; storing the second key-value data in the key-value data and corresponding to at least one part of the other layers except the first layer into the second storage device; when performing an inference process with respect to the first layer, reading the first key-value data corresponding to the first layer from the cache blocks, and reading the second key-value data corresponding to the first layer from the at least one shared block.

In an exemplary embodiment of this disclosure, an access speed of the first storage device is greater than an access speed of the second storage device, and a size of the key-value data is greater than a capacity of the first storage device.

In an exemplary embodiment of this disclosure, the data caching method further includes: after completing the inference process associated with the first layer, moving the second key-value data corresponding to a new token from the at least one shared block to the second storage device; reading the second key-value data corresponding to a second layer of the layers from the second storage device to the at least one shared block; when performing an inference process with respect to the second layer, reading the first key-value data corresponding to the second layer from the cache blocks, and reading the second key-value data corresponding to the second layer from the at least one shared block.

In an exemplary embodiment of this disclosure, the data caching method further includes: obtaining a token length supported by the neural network; determining a quantity of the cache blocks and a quantity of the at least one shared block according to the token length. In an exemplary embodiment of this disclosure, the step of determining the quantity of the cache blocks and the quantity of the at least one shared block according to the token length includes: obtaining a sum of the blocks of the first storage device; configuring the quantity of the cache blocks and the quantity of the at least one shared block to be equal to the sum of the blocks; dividing the token length by a block size to obtain a block length; calculating a minimum value of the quantity of the at least one shared block under a condition that a product obtained by multiplying the quantity of the at least one shared block by the quantity of the layers is added to the quantity of the cache blocks to obtain a value, and the value is greater than or equal to the block length.

In an exemplary embodiment of this disclosure, the data caching method further includes: gradually increasing the token length as the neural network continues to generate a plurality of output tokens, wherein the block length is greater than the sum of the blocks.

In an exemplary embodiment of this disclosure, the data caching method further includes: generating a plurality of output tokens by the neural network, and connecting the output tokens to the tokens to obtain a plurality of historical tokens; obtaining a first prefix of the historical tokens; calculating a first hash value of the first prefix; storing the first hash value and the key-value data corresponding to the first prefix into the second storage device.

In an exemplary embodiment of this disclosure, the data caching method further includes: obtaining a second prefix of the historical tokens, wherein the second prefix covers the first prefix; calculating a second hash value of the second prefix; storing the second hash value and the key-value data corresponding to the second prefix into the second storage device.

In an exemplary embodiment of this disclosure, the step of storing the first hash value and the key-value data corresponding to the first prefix into the second storage device includes: determining whether the first hash value hits a first previous hash value of a third storage device, wherein an access speed of the third storage device is greater than an access speed of the second storage device, and the access speed of the third storage device is less than an access speed of the first storage device; if the first hash value does not hit the first previous hash value, determining whether the third storage device is full; if the third storage device is not full, writing the first hash value and the key-value data corresponding to the first prefix into the third storage device; if the third storage device is full, determining whether the second storage device is full; if the second storage device is full, clearing data in the second storage device; if the second storage device is not full, selecting a previous key-value data in the third storage device; determining whether a hash value of the previous key-value data hits a second previous hash value of the second storage device; if the hash value of the previous key-value data does not hit the second previous hash value, moving the previous key-value data to the second storage device.

In an exemplary embodiment of this disclosure, the data caching method further includes: when performing an inference process with respect to one of the layers, the cache blocks store the first key-value data of M layers of the layers, and the at least one shared block stores the second key-value data of N layers of the layers, wherein the cache blocks and the at least one shared block are distributed on one memory chip, M and N are positive integers, and M is greater than N.

In an exemplary embodiment of this disclosure, the step of obtaining the key-value data corresponding to the layers: obtaining a prefix of the tokens; calculating a hash value of the prefix; determining whether the hash value hits a previous hash value stored into the second storage device; if the hash value hits the previous hash value, reading key-value data corresponding to the prefix from the second storage device.

From another perspective, an exemplary embodiment of this disclosure provides a host system, including a processor and a second storage device, and the processor includes a first storage device. The processor is electrically connected to the second storage device and configured to execute the data caching method described above.

In order to make the above-mentioned features and advantages of the disclosure comprehensible, embodiments accompanied with drawings are described in detail below.

### BRIEF DESCRIPTION OF THE DRAWINGS

FIG. 1 is a schematic diagram of a host system and an input/output (I/O) device according to an exemplary embodiment of the disclosure.

FIG. 2 is a schematic diagram of a host system, a storage device, and an I/O device according to an exemplary embodiment of the disclosure.

FIG. 3 is a schematic diagram of a storage device according to an exemplary embodiment of the disclosure.

FIG. 4 is a schematic diagram of a memory hierarchy according to an exemplary embodiment.

FIG. 5 is a schematic diagram of a neural network during an inference process according to an exemplary embodiment.

FIG. 6 is a schematic diagram of partitioning a storage device into a plurality of blocks according to an exemplary embodiment.

FIG. 7 is a schematic diagram of data during an inference process performed with respect to a first layer according to an exemplary embodiment.

FIG. 8 is a schematic diagram of data during the inference process performed with respect to a second layer according to an exemplary embodiment.

FIG. 9 is a schematic diagram of merging key-value data of cache blocks and at least one shared block according to an exemplary embodiment.

FIG. 10 is a schematic diagram of a conversation record according to an exemplary embodiment.

FIG. 11 is a schematic diagram of another conversation record according to an exemplary embodiment.

FIG. 12 is a flowchart of reading the key-value data according to an exemplary embodiment.

FIG. 13 is a flowchart of writing the key-value data according to an exemplary embodiment

FIG. 14 is a flowchart of a data caching method according to an exemplary embodiment.

### DETAILED DESCRIPTION OF DISCLOSED EMBODIMENTS

A portion of the exemplary embodiments of the disclosure will be described in detail with reference to the accompanying drawings. Element symbol referenced in the following description will be regarded as the same or similar element when the same element symbol appears in different drawings. These examples are only a portion of the disclosure and do not disclose all possible embodiments of the disclosure. M ore precisely, these exemplary embodiments are only examples of the system and method within the scope of the patent application of the disclosure.

The terminologies “first”, “second”, etc. used in this document do not specifically refer to the sequence or order, but are only used to distinguish components or operations described with the same technical terminologies.

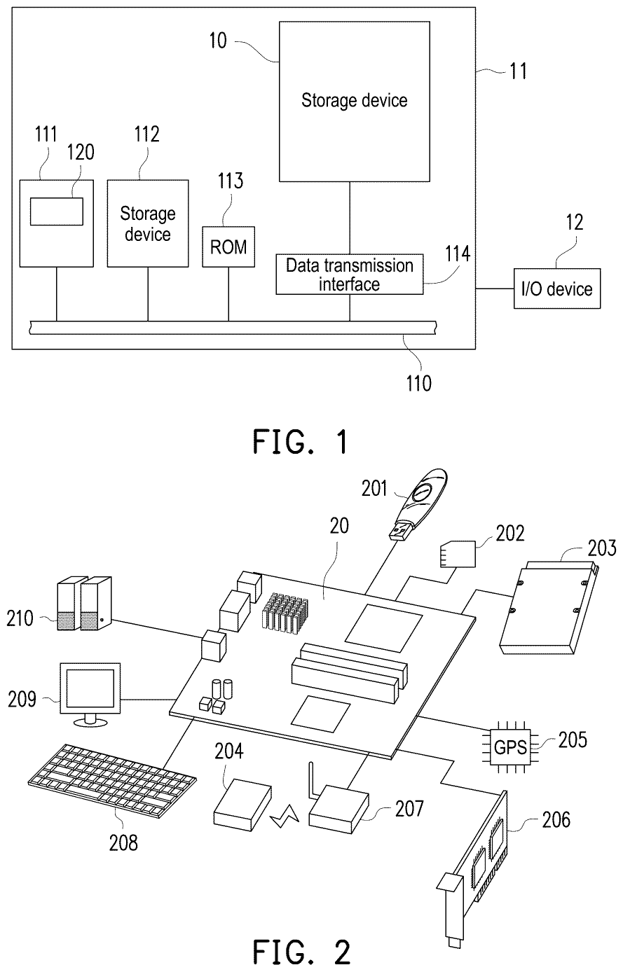

FIG. 1 is a schematic diagram of a host system and an input/output (I/O) device according to an exemplary embodiment of the disclosure. FIG. 2 is a schematic diagram of a host system, a storage device, and an I/O device according to an exemplary embodiment of the disclosure.

With reference to FIG. 1 and FIG. 2, a host system 11 is a computer system. This computer system may be a desktop computer, a server, a distributed system, a laptop, and so on, but the disclosure is not limited thereto. A host system 11 may include a processor 111, a storage device 112, a read only memory (ROM) 113, and a data transmission interface 114. The storage device 112 is, for instance, a random-access memory (RAM).

The processor 111, the storage device 112, the RAM, and the data transmission interface 114 may be coupled to a system bus 110. In some exemplary embodiments, the storage device 112 may be connected to the processor 111 through a dedicated data transmission interface rather than through the system bus 110. The processor 111 may be a graphic processing unit (GPU), a tensor processing unit (TPU), a neural processing unit (NPR), etc. The processor 111 is also provided with a storage device 120, and the storage device 120 is, for instance, a video RAM (VRAM).

In an exemplary embodiment, the processor 111 may be coupled to a storage device 10 through the data transmission interface 114. For instance, the processor 111 may store data into or read dataform the storage device 10 via the data transmission interface 114. In addition, the host system 11 may be coupled to an I/O device 12 through the system bus 110. For instance, the host system 11 may transmit output signals to or receive input signals from the I/O device 12 via the system bus 110. In other exemplary embodiments, the processor 111 may also be electrically connected to the storage device 10 through a dedicated data transmission interface 114 rather than through the system bus 110.

In an exemplary embodiment, the processor 111, the storage device 112, the ROM 113, and the data transmission interface 114 may be disposed on a motherboard 20 of the host system 11. The number of the data transmission interface 114 may be one or more. The motherboard 20 may be coupled to the storage device 10 through the data transmission interface 114 via a wired or wireless connection.

In an exemplary embodiment, the storage device 10 may be, for instance, a flash drive 201, a memory card 202, or a solid-state drive (SSD) 203. In some exemplary embodiments, the storage device 10 may be disposed outside the host system 11 as a wireless storage device 204. The wireless storage device 204 may be a storage device based on various wireless communication technologies, such as a near field communication (NFC) storage device, a wireless fax (Wi-Fi) storage device, a Bluetooth storage device, a low power Bluetooth storage device (e.g., iBeacon), and so on. In addition, a motherboard 20 may also be coupled to various I/O devices, such as a global positioning system (GPS) module 205, a network interface card 206, a wireless transmission device 207, a keyboard 208, a screen 209, a speaker 210, and so forth, through the system bus 110. For instance, in an exemplary embodiment, the motherboard 20 may access the wireless storage device 204 through the wireless transmission device 207.

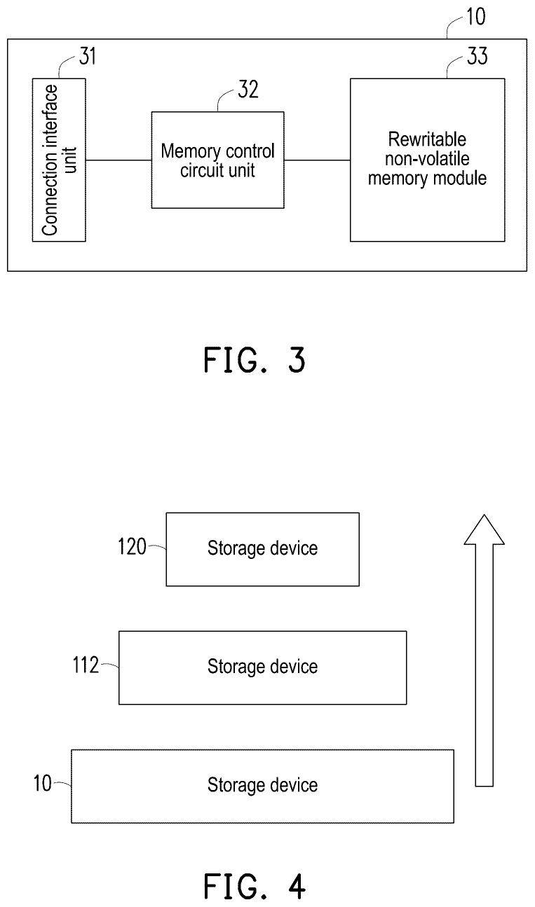

FIG. 3 is a schematic diagram of a storage device according to an exemplary embodiment of the disclosure. With reference to FIG. 3, the storage device 10 includes a connection interface unit 31, a memory control circuit unit 32, and a rewritable non-volatile memory module 33.

The connection interface unit 31 is configured to couple to a processor 111. The storage device 10 may communicate with the processor 111 via the connection interface unit 31. In an exemplary embodiment, the connection interface unit 31 is compatible with the peripheral component interconnect express (PCI Express) standard. In an exemplary embodiment, the connection interface unit 31 may also be compliant to the serial advanced technology attachment (SATA) standard, the parallel advanced technology attachment (PATA) standard, the institute of electrical and electronics engineers (IEEE) 1394 standard, the universal serial bus (USB) standard, the SD interface standard, the ultra-high speed-I (UHS-I) interface standard, the ultra-high speed-II (UHS-II) interface standard, the memory stick (MS) interface standard, the MCP interface standard, the MMC interface standard, the eMMC interface standard, the universal flash storage (UFS) interface standard, the eMCP interface standard, the CF interface standard, the integrated device electronics (IDE) standard, or other suitable standards. The connection interface unit 31 may be packaged in a chip with the memory control circuit unit 32, or the connection interface unit 31 may be disposed outside a chip including the memory control circuit unit 32.

The memory control circuit unit 32 is coupled to the connection interface unit 31 and the rewritable non-volatile memory module 33. The memory control circuit unit 32 is used to execute multiple logic gates or control commands implemented in a hardware form or a firmware form and to perform operations such as writing, reading, and erasing of data in the rewritable non-volatile memory module 33 according to the commands of the processor 111.

The rewritable non-volatile memory module 33 is used to store the data written by the processor 111. The rewritable non-volatile memory module 33 may include a single level cell (SLC) NAND-type flash memory module (i.e., a flash memory that may store 1 bit in one memory cell), multi-level cell (MLC) NAND-type flash memory module (i.e., a flash memory module that may store 2 bits in one memory cell), a triple level cell (TLC) NAND-type flash memory module (i.e., a flash memory module that may store 3 bits in one memory cell), a quad level cell (QLC) NAND-type flash memory module (i.e., a flash memory module that may store 4 bits in one memory cell), other flash memory modules, or other memory modules with the same characteristics.

Each memory cell in the rewritable non-volatile memory module 33 stores one or more bits by a change in a voltage (also referred to as a threshold voltage hereinafter). Specifically, there is a charge trapping layer between a control gate and a channel of each of the memory cells. By applying a write voltage to the control gate, the number of electrons in the charge trapping layer may be changed, thereby changing the threshold voltage of the memory cell. This operation of changing the threshold voltage of the memory cell is also referred to as “writing data to the memory cell” or “programming the memory cell”. As the threshold voltage changes, each of the memory cells in the rewritable non-volatile memory module 33 has multiple storage statuses. By applying a read voltage, it is possible to determine which storage status a memory cell belongs to, thereby obtaining the one or more bits stored into the memory cell.

In an exemplary embodiment, the memory cells of the rewritable non-volatile memory module 33 may constitute multiple physical programming units, and the physical programming units may constitute multiple physical erasing units. Specifically, memory cells on the same word line may form one or more physical programming units. If each memory cell may store two or more bits, the physical programming units on the same word line may be classified at least as lower physical programming units and upper physical programming units. For instance, the least significant bit (LSB) of a memory cell belongs to a lower physical programming unit, and the most significant bit (MSB) of a memory cell belongs to an upper physical programming unit. Generally, in an MLC NAND flash memory, the write speed of the lower physical programming unit is greater than the write speed of the upper physical programming unit, and/or the reliability of the lower physical programming unit is higher than the reliability of the upper physical programming unit.

In some exemplary embodiments, the processor 111 or the memory control circuit unit 32 may determine a programming mode for writing data into the rewritable non-volatile memory module 33. When using the single level cell programming mode, data is written to the next physical programming unit. When using a multi-level (including two-level, three-level, four-level, etc.) cell programming mode, data is written into at least the lower physical programming unit and the upper physical programming unit.

FIG. 4 is a schematic diagram of a memory hierarchy according to an exemplary embodiment. With reference to FIG. 4, in this exemplary embodiment, an access speed of each storage device 120, 112, and 10 is not the same. The access speed of the storage device 120 is greater than the access speed of the storage device 112, and the access speed of the storage device 112 is greater than the access speed of the storage device 10. In some exemplary embodiments, the capacity of the storage device 120 is less than the capacity of the storage device 112, and the capacity of the storage device 112 is less than the capacity of the storage device 10, but the disclosure is not limited thereto. A data caching method is provided here, where the storage device 120 is configured to store data needed by a neural network during an inference process. However, since the capacity of the storage device 120 may not be sufficient, part of the data may be stored into the storage device 112 or the storage device 10. In this exemplary embodiment, three storage devices 120, 112, and 10 are used, but in other exemplary embodiments, more or fewer storage devices may be used. For instance, in some exemplary embodiments, the storage device 112 may be omitted, and data that cannot fit in the storage device 120 are stored into the storage device 10.

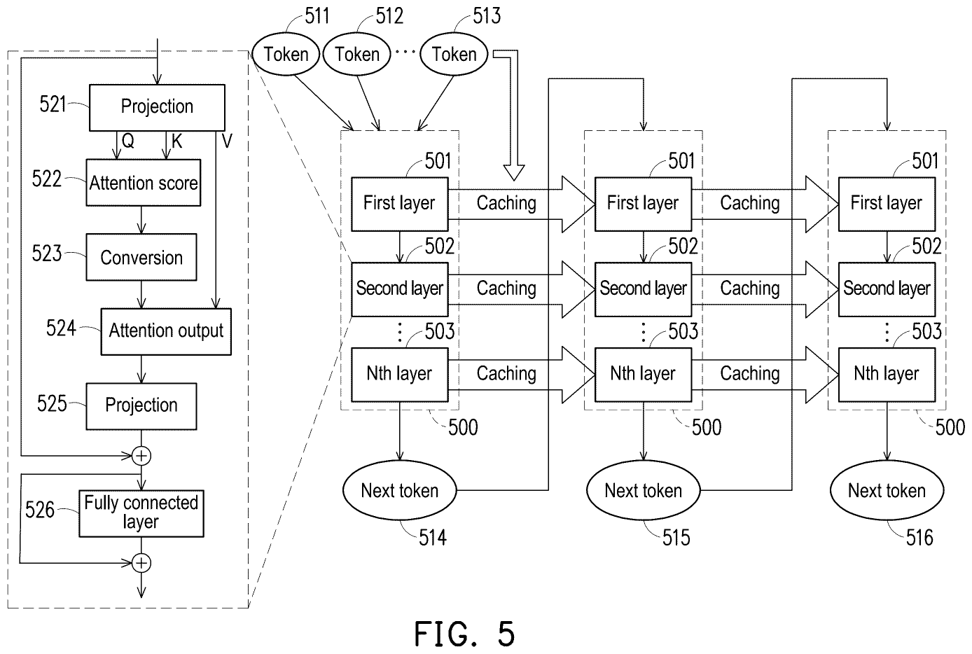

FIG. 5 is a schematic diagram of a neural network during an inference process according to an exemplary embodiment. With reference to FIG. 5, a neural network 500 includes a first layer 501, a second layer 502, . . . , up to an N^{th} layer 503, where N is a positive integer. The input of the neural network 500 is multiple tokens 511 to 513. Each token may be text data, voice data, image data, or other types of data, but the disclosure is not limited thereto. Each token is a vector generated by encoding or other processing. Here, it represents the operational unfolding of neural network 500 at various time points. Specifically, the neural network 500 outputs the next token 514, and the next token 514 is fed back as the input of the neural network 500 to generate the next token 515. Likewise, the next token 515 is fed back as the input of the neural network 500 to generate the next token 516. Such a mechanism is also referred to as autoregressive (AT).

Each of the first layer 501 to the N^{th} layer 503 is also referred to as a decoder, and the architectures of these decoders are the same. The output of the first layer 501 may also be referred to as a token, an embedding, or a feature vector. The output of the first layer 501 is transmitted to the second layer 502, and the output of the second layer 502 is transmitted to the next layer until it is transmitted to the N^{th} layer 503. In FIG. 5, the architecture of the second layer 502 is magnified as an example.

The operation of the second layer 502 includes steps 521 to 526. Generally, projection is performed in step 521 to obtain a query matrix Q, a key matrix K, and a value matrix V. In step 522, an attention score is calculated by multiplying the query matrix Q to the key matrix K. In step 523, conversion is performed on these attention scores. This conversion is, for instance, a soft-max method, and in other exemplary embodiments, a sparsemax method may also be used. Then in step 524, the converted attention scores are multiplied with the value matrix V and summed to calculate an attention output. In step 525, the attention output may be projected again and added with the input token, which is also referred to as a residual layer. Finally, in step 526, the output of this layer is obtained through a fully connected layer. Steps 522 to 524 are also referred to as self-attention calculations.

In this case, the key matrix K and the value matrix V are collectively referred to as key-value data. The inference process can be roughly divided into two stages: prefilling and decoding. During the prefilling stage, the key-value data for all tokens 511 to 513 are calculated, and the key-value data are stored into the storage device. During the decoding stage, the key-value data are read from the storage device, avoiding repeated calculations.

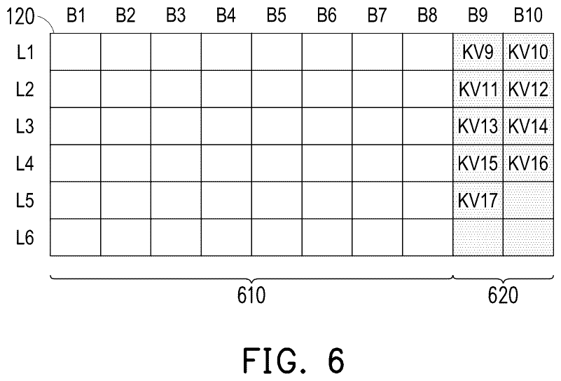

FIG. 6 is a schematic diagram of partitioning a storage device into a plurality of blocks according to an exemplary embodiment. With reference to FIG. 6, the memory space of the storage device 120 is partitioned into a plurality of blocks B1 to B10, and each block represents the memory space in a vertical direction. Additionally, it is assumed that the neural network 500 has 6 individual layers L1 to L6, which correspond to the memory space in a horizontal direction. After inputting a plurality of tokens into the neural network 500, the key-value data corresponding to these layers and tokens are first calculated. The size of the key-value data corresponding to each token is 2*6*D, where 2 represents the key and the value, 6 represents the number of layers L1 to L6, and D represents the vector length. Each space in FIG. 6 may store the key-value data corresponding to one or more tokens. For simplicity, it is assumed here that each space may store the key-value data corresponding to one token. Therefore, the entire storage device 120 may store the key-value data corresponding to 10 tokens and six layers. For instance, the first space in the block B1 in FIG. 6 may store the key-value data of the first token in the first layer L1, the second space in the block B1 may store the key-value data of the first token in the second layer L2, the first space in the block B2 may store the key-value data of the second token in the first layer L1, and the rest can be deduced therefrom.

When the number of tokens is less than or equal to 10, the storage device 120 may store the key-value data for all tokens. However, when the number of tokens exceeds 10, these key-value data cannot be stored simultaneously in the storage device 120. Therefore, in this exemplary embodiment, these blocks B1 to B10 are partitioned into a plurality of cache blocks 610 and at least one shared block 620. In this exemplary embodiment, the blocks B1 to B8 are the cache blocks 610, while the blocks B9 and B10 are the at least one shared block 620. Additionally, all key-value data are also partitioned into two parts: the first key-value data and the second key-value data. For instance, the key-value data corresponding to the first to eighth tokens are the first key-value data, while the key-value data corresponding to the ninth token and beyond are the second key-value data. The first key-value data corresponding to all layers L1 to L6 are stored into their respective corresponding cache blocks 610. For instance, the first key-value data of the first layer L1 are stored into the blocks B1 to B8 of the first layer L1; the first key-value data of the second layer L2 are stored into the blocks B1 to B8 of the second layer L2, and so on. Specifically, only the second key-value data of a certain layer are stored into the shared block 620, thereby storing all key-value data of that layer in the storage device 120. For instance, in FIG. 6, the second key-value data KV9 to KV17 of the first layer L1 are stored into the shared block 620, where the second key-value data KV9 to KV17 correspond to the ninth to seventeenth tokens, respectively. On the other hand, the second key-value data of at least one part of the other layers L2 to L6, except for the first layer L1, are stored into another storage device (e.g., the storage device 112 or the storage device 10). For instance, the second key-value data of the layers L2 to L6 may be stored into the storage device 112; or one portion of the second key-value data of the layers L2 to L6 may be stored into the storage device 112, and the other portion of the second key-value data of layers L2 to L6 may be stored into the storage device 10; or when there is idle space in the shared block 620, one portion of the second key-value data of the layers L2 to L6 may also be stored into the shared block 620, while the remaining second key-value data stored into the storage device 112.

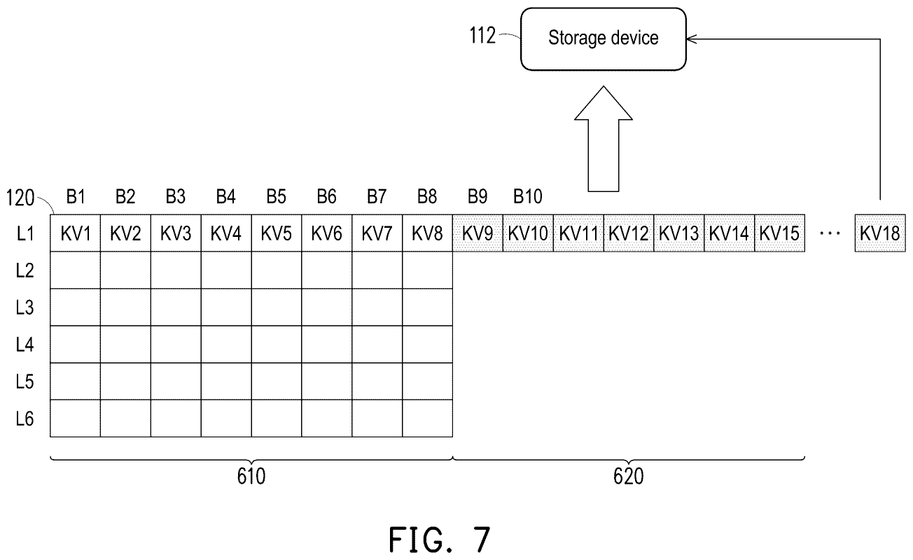

FIG. 7 is a schematic diagram of data during the inference process performed with respect to the first layer according to an exemplary embodiment. With reference to FIG. 6 and FIG. 7, when the inference process is performed with respect to the first layer L1, the first key-value data KV1 to KV8 corresponding to the first layer L1 may be read from the cache blocks 610, and the second key-value data KV9 to KV17 corresponding to the first layer L1 may be read from the shared block 620. H ere, the second key-value data KV9 to KV17 are shown at the position of the first layer L1, but their actual storage location is as shown in FIG. 6. During the inference process, a new token (i.e., the eighteenth token) is also generated; for instance, when the next token 514 in FIG. 5 is input to the neural network, the corresponding key-value data KV18 are also generated and stored into the shared block 620. After the inference process on the first layer L1 is completed, the second key-value data KV9 to KV18 in the shared block 620 are moved to the storage device 112.

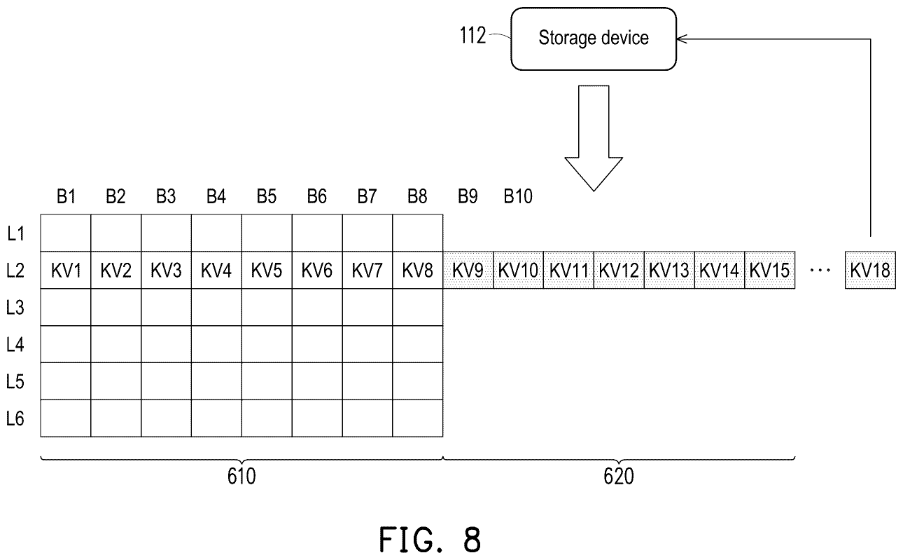

FIG. 8 is a schematic diagram of data during the inference process performed with respect to the second layer according to an exemplary embodiment. When the inference process is performed with respect to the second layer L2, the second key-value data KV9 to KV17 corresponding to the second layer L2 are read from the storage device 112 to the shared block 620. During the inference process performed with respect to the second layer L2, the first key-value data KV1 to KV8 corresponding to the second layer L2 may be read from the cache blocks 610, and the second key-value data KV9 to KV17 corresponding to the second layer L2 may be read from the shared block 620. Similarly, the key-value data KV18 for a new token are generated during the inference process on the second layer L2. After the inference process on the second layer L2 is completed, the key-value data KV18 corresponding to the second layer L2 are written to the storage device 112.

In other words, when the inference process is performed with respect to a certain layer, the first key-value data are read from the cache blocks 610, and the second key-value data are read from the shared block 620. After the inference process is completed, the key-value data in the shared block 620 (including the key-value data of the new token) are written to the storage device 112. The storage device 120 was originally able to process a token length of 10, and through this method, the token length that can be processed can be increased to 20.

From another perspective, when the inference process is performed with respect to a certain layer, the cache blocks 610 store the first key-value data of M layers, and the shared block 620 stores the second key-value data of N layers. M and N are positive integers, and M is greater than N. In this exemplary embodiment, M=6 and N=1, but in other exemplary embodiments, M=6 and N=2. This disclosure does not pose limitations to the values of the positive integers M and N. On the other hand, the cache blocks 610 and the shared block 620 are distributed on the same memory chip.

In some exemplary embodiments, the quantity of the shared block 620 may be dynamically determined. Specifically, the token length supported by the neural network may be obtained first, and then the quantity of the cache blocks 610 and the quantity of the shared block 620 may be determined according to this token length. When the token length is larger, more shared blocks 620 are needed to store tokens of the same layer; when the token length is smaller, fewer shared blocks 620 may be designed to reduce reading data from and writing data to the storage device 112.

Assuming the quantity of the cache blocks 610 is X, the quantity of the shared block 620 is Y, and the sum of the blocks of the storage device 120 is represented as Z. In some exemplary embodiments, X and Y can be determined according to the following mathematical formula.

$$X + Y = Z \qquad [ Mathematical formula 1 ]$$

$$X + ( Y \times {N}_{L} ) \geq \frac{{L}_{M}}{{S}_{B}} \qquad [ Mathematical formula 2 ]$$

Here, N_{L} represents the number of all layers in the neural network, L_{M} represents the token length supported by the neural network, and S_{B} represents the block size, indicating how many tokens each block can store. In this exemplary embodiment, S_{B}=1. L_{M}/S_{B} represents the block length, representing how many blocks the neural network can support. In mathematical formula 1, the quantity X of the cache blocks and the quantity Y of the shared blocks are configured to be equal to the sum Z of all blocks. In mathematical formula 2, the objective is to calculate the minimum value of Y under the condition that the product of the quantity Y of the shared blocks and the quantity L of layers is obtained, and the quantity X of the cache blocks is added to the product to obtain a value, and the obtained value should be greater than or equal to the block length L_{M}/S_{B}. Taking the exemplary embodiment depicted in FIG. 8, X=8, Y=2, and Z=10 can be substituted into mathematical formula 1 and mathematical formula 2, and mathematical formula 2 can be rewritten as 2×L+8≥Lm, where Y=2 is the minimum value satisfying the condition. This value can simultaneously support longer token lengths while avoiding excessive read/write operations to the storage device 112.

In some embodiments, the token length L_{M} can also be increased progressively. The token length that can be supported by a language model may be several thousand or tens of thousands, and configuring the token length L_{M} to such large values may lead to generation of excessive shared blocks. Therefore, as the neural network continues to generate output tokens, the token length can be gradually increased when there are insufficient shared blocks. For instance, the token length L_{M} can initially be set to 100, then increased to 200, and gradually increased to the supported upper limit. At this time, the calculated block length L_{M}/S_{B} is greater than the sum Z of all blocks, but due to the shared blocks, the storage device 120 can still store this token volume.

Please refer to FIG. 6, where the key-value data KV9 to KV17 are stored alternately in the block B9 and the block B10. When the key-value data in the shared block 620 are written to the storage device 112 or the storage device 10, the key-value data in the same block are stored into the same file. Therefore, the first file stores the key-value data KV9, KV11, KV13, KV15, and KV17, and the second file stores the key-value data KV10, KV12, KV14, and KV16. Each layer corresponds to two files, and thus a total of 2*6=12 files can be generated. However, in other exemplary embodiments, the key-value data of the same layer can also be stored into the same file, or each piece of key-value data can be stored into a separate file, which should not be construed as a limitation in the disclosure. On the other hand, the key-value data KV9 to KV17 may be stored sequentially in the block B9 first and then stored into the block B10. The arrangement manner of the key-value data KV9 to KV17 is not limited in the disclosure.

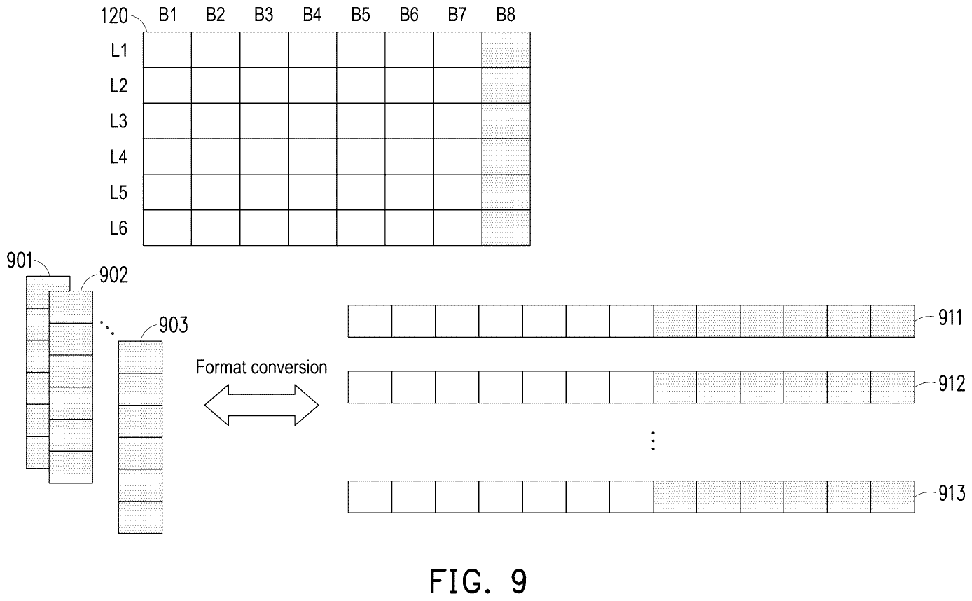

FIG. 9 is a schematic diagram of merging the key-value data in the cache blocks and the shared block according to an exemplary embodiment. With reference to FIG. 9, in this exemplary embodiment, the storage device 120 has a total of 8 blocks B1 to B8, where the blocks B1 to B7 are the cache blocks, and the block B8 is the shared block. In this exemplary embodiment, a total of 6 files (such as files 901 to 903) can be generated to store the second key-value data corresponding to the six layers L1 to L6. Specifically, in this exemplary embodiment, the key-value data in the cache blocks may also be stored into the storage device 112 or the storage device 10. In such an exemplary embodiment, the key-value data of the same layer (including the first key-value data and the second key-value data) all belong to the same file. Since the first key-value data of the same layer are arranged horizontally in the storage device 120, but the second key-value data are arranged vertically, format conversion is necessary. In other words, it is necessary to first read the file 901 corresponding to the first layer L1 from the storage device 112 or the storage device 10, convert the second key-value data in this file 901 to a horizontal arrangement following the first key-value data of the first layer L1 to form the file 911, and then write the file 911 into the storage device 112 or the storage device 10. Similarly, for the second layer L2, the file 902 is first read, the second key-value data in this file 902 are converted to a horizontal arrangement following the first key-value data of the second layer L2 to form the file 912, and then the file 912 is written to the storage device 112 or the storage device 10. Therefore, a total of six files (including files the 911 to 913) can be generated to store all the key-value data corresponding to all the layers L1 to L6.

When both the first key-value data and the second key-value data are stored into the storage device 112 or the storage device 10, if the same input content appears subsequently, the corresponding key-value data can be directly read from the storage device 112 or the storage device 10 to the storage device 120, thereby reducing calculation time. In some exemplary embodiments, hash values of the corresponding tokens can also be calculated, and these hash values are also stored into the storage device 112 or the storage device 10, and subsequently the corresponding key-value data can be found through comparison of the hash values.

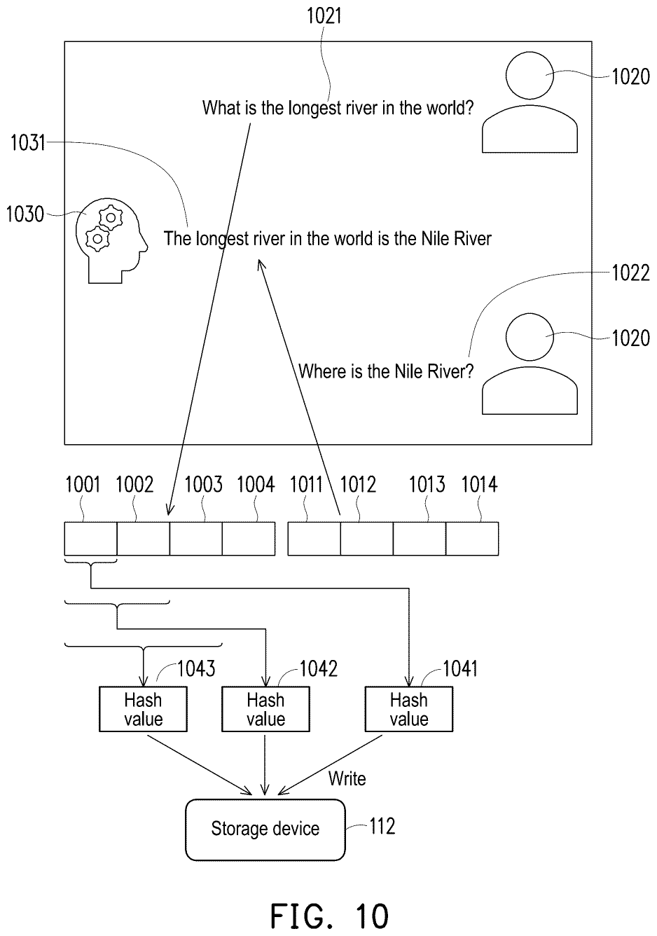

FIG. 10 is a schematic diagram of a conversation record according to an exemplary embodiment. In the related art, only the key-value data of the current conversation are temporarily stored, but during the inference process, the key-value data of all conversation records are used, and thus the inference speed of the model becomes slower and slower. In this exemplary embodiment, a long-term key-value cache is to be established. For instance, a user 1020 and a chat robot 1030 are having a conversation. The first sentence 1021 input by the user 1020 is “What is the longest river in the world?”, this sentence 1021 is converted into tokens 1001 to 1004, and the corresponding key-value data are also calculated. When the chat robot 1030 performs the inference process, it uses the key-value data of the first sentence 1021, and the chat robot 1030 generates a plurality of the output tokens 1011 to 1014. These output tokens 1011 to 1014 are converted into a sentence 1031, with the content “The longest river in the world is the N ile River”. These output tokens 1011 to 1014 are connected to and following the tokens 1001 to 1004, collectively referred to as a plurality of historical tokens. Next, a plurality of prefixes of these historical tokens are obtained, hash values of the prefixes are calculated, and finally the hash values and the corresponding key-value data are stored into the storage device 112. For instance, the token 1001 forms a first prefix, so that a hash value 1041 of the token 1001 and the corresponding key-value data are written to the storage device 112. The tokens 1001 and 1002 form a second prefix, so that a hash value 1042 of the tokens 1001 and 1002 and the corresponding key-value data are written to the storage device 112. The tokens 1001 to 1003 form a third prefix, so that a hash value 1043 of the tokens 1001 to 1003 and the corresponding key-value data are written to the storage device 112. The second prefix covers the first prefix, and the third prefix covers the second prefix. From another perspective, the first prefix is a subset of the second prefix, and the second prefix is a subset of the third prefix. The above process repeats continuously until the hash values of all tokens 1001 to 1004 and 1011 to 1014 are calculated, which means in the exemplary embodiment depicted in FIG. 10, there are a total of ten prefixes, and the hash value of each prefix and the corresponding key-value data are written to the storage device 112.

Next, the user 1020 inputs a sentence 1022. During inference, the key-value data of the sentence 1021 and the sentence 1031 are needed. At this time, the hash value of the combined sentence 1021 and sentence 1031 can be calculated, and this hash value hits the hash value in the storage device 112 (referred to as the previous hash value). Therefore, the key-value data corresponding to the sentence 1021 and the sentence 1031 can be read from the storage device 112. In this way, when the user 1020 inputs the sentence 1022, there is no need to repeatedly calculate the key-value data of the sentences 1021 and 1031. This approach saves more and more time as the conversation progresses because the conversation record becomes longer and more key-value data are required to be calculated.

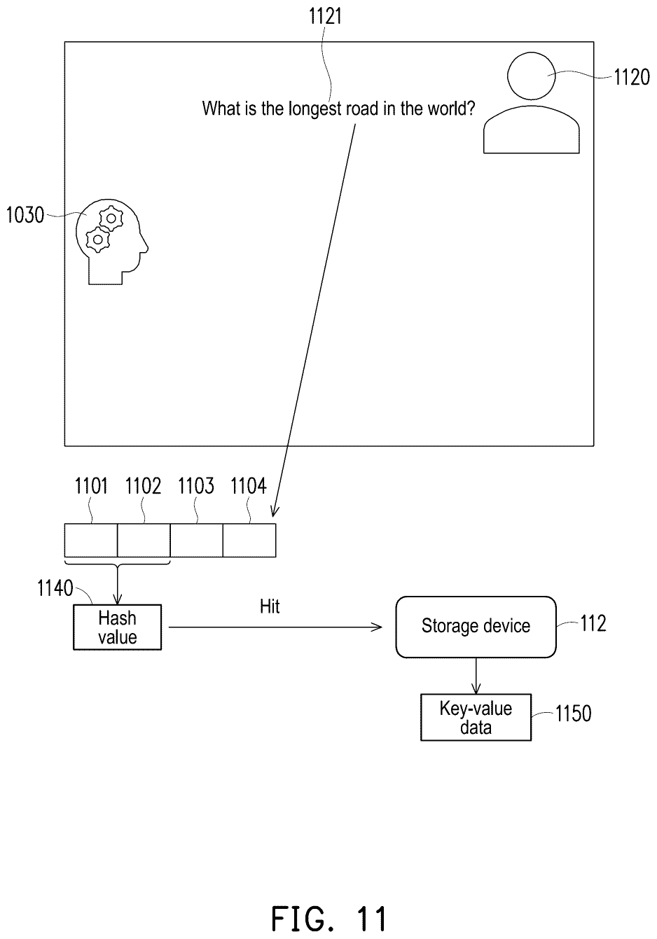

In this exemplary embodiment, the hash value of a prefix is calculated, and therefore a sentence does not need to be exactly the same as the previous sentence and the matching key-value data can still be found. For instance, FIG. 11 is a schematic diagram of another conversation record according to an exemplary embodiment. With reference to FIG. 10 and FIG. 11, a user 1120 is different from the user 1020, or these two users may be the same but FIG. 10 and FIG. 11 belong to different chat windows. The user 1120 inputs a sentence 1121, and this sentence 1121 and the sentence 1021 have a common prefix, namely “What is the longest”. The sentence 1121 is converted into a plurality of tokens 1101 to 1104. Next, a plurality of prefixes are obtained from these tokens 1101 to 1104, hash values of these prefixes are calculated, and it is determined whether these hash values hit the previous hash values in the storage device 112. For instance, the token 1101 forms the first prefix; the tokens 1101 and 1102 form the second prefix; the tokens 1101 to 1103 form the third prefix; the tokens 1101 to 1104 form the fourth prefix. In this exemplary embodiment, the hash value of the tokens 1101 and 1102 (corresponding to “W hat is the longest”) hits the previous hash value in the storage device 112, and therefore the key-value data 1150 corresponding to the second prefix may be read from the storage device 112. In this way, there is no need to repeatedly calculate the key-value data of tokens 1101 and 1102.

In some exemplary embodiments, the approaches illustrated in FIG. 10 and FIG. 11 can be applied to retrieval augmented generation (RAG). On one hand, in some applications, users may frequently input the same questions; for instance, in financial customer services, “what to do if a credit card is lost” is often asked, or in medical customer services, the same symptoms are repeatedly queried. On the other hand, if the chat robot 1030 search a fixed database, the chat robot obtains the same reference materials for the same questions, and the key-value data of these reference materials are also stored into the storage device 112, thereby reducing calculations. In other words, the historical tokens mentioned above may also include tokens of the text obtained after searching the database.

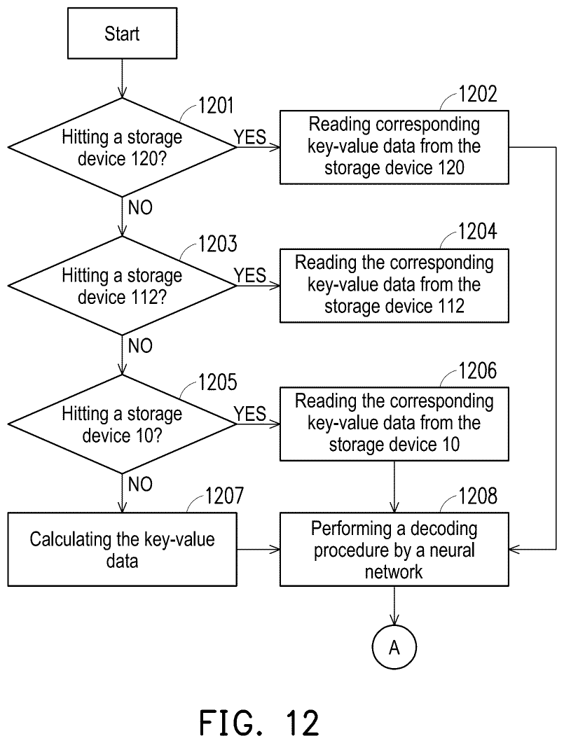

FIG. 12 is a flowchart of reading the key-value data according to an exemplary embodiment. With reference to FIG. 4 and FIG. 12, in this exemplary embodiment, there are three storage devices 120, 112, and 10. When the key-value data are read or written, the it is sequentially determined whether the data have already been stored into these three storage devices 120, 112 and 10. For a certain prefix, a hash value is first calculated. In step 1201, it is determined whether this hash value hits a previous hash value stored into the storage device 120. If yes, in step 1202, the corresponding key-value data are read from the storage device 120. If the result of step 1201 is no, in step 1203, it is determined whether the hash value hits a previous hash value stored into the storage device 112. If the result of step 1203 is yes, step 1204 is executed to read the corresponding key-value data from the storage device 112. If the result of step 1203 is no, step 1205 is executed to determine whether the hash value hits a previous hash value stored into the storage device 10. If the result of step 1205 is yes, step 1206 is executed to read the corresponding key-value data from the storage device 10. If the result of step 1205 is no, step 1207 is executed to calculate the key-value data. After calculating the key-value data for all tokens, in step 1208, the neural network performs the decoding procedure.

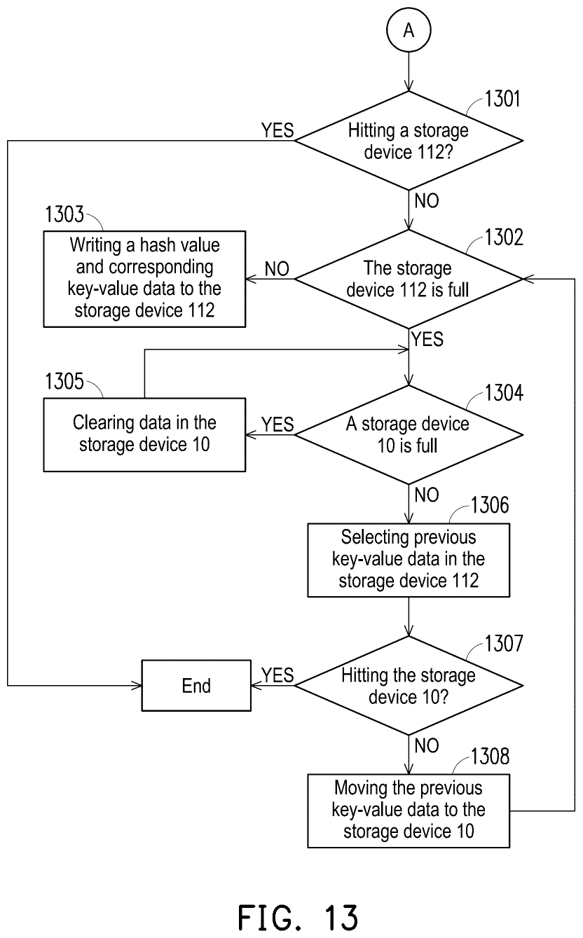

After the neural network completes the decoding procedure, a plurality of historical tokens are obtained (with reference to FIG. 10), and the hash value of the prefix is calculated. Next, please refer to FIG. 13, which is a flowchart of writing the key-value data according to an exemplary embodiment. In step 1301, it is determined whether this hash value hits a previous hash value in the storage device 112. If yes, it indicates that the corresponding key-value data have already been stored into the storage device 112, and thus this process can be ended. If the result of step 1301 is no, in step 1302, it is determined whether the storage device 112 is full. If the storage device 112 is not full, in step 1303, the hash value and the corresponding key-value data are written to the storage device 112. If the storage device 112 is full, in step 1304, it is determined whether the storage device 10 is full. If the result of step 1304 is yes, a part of the data in the storage device 10 is cleared in step 1305, and the process returns to step 1304. If the storage device 10 is not full, in step 1306, the previous key-value data in the storage device 112 are selected, for instance, the least recently used key-value data may be selected. In step 1307, it is determined whether the hash value of the previous key-value data hits a previous hash value in the storage device 10. If the result of step 1307 is yes, it indicates that the corresponding key-value data have already been stored into the storage device 10, and thus the process can be ended. If the result of step 1307 is no, in step 1308, the previous key-value data are moved to the storage device 10, and then the process returns to step 1302.

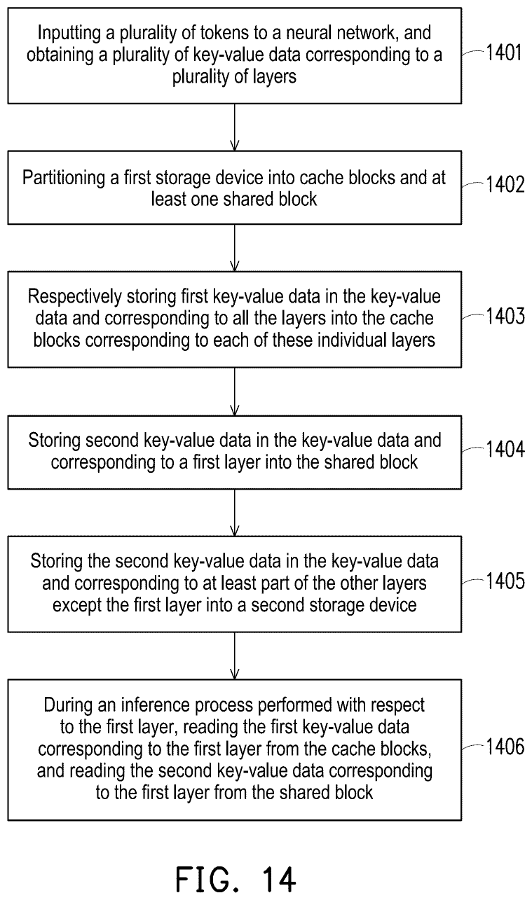

FIG. 14 is a flowchart of a data caching method according to an exemplary embodiment. With reference to FIG. 14, in step 1401, a plurality of tokens are input to the neural network, and a plurality of key-value data corresponding to a plurality of layers are obtained. In some exemplary embodiments, the key-value data of all the layers can be calculated directly; in other exemplary embodiments, partial or all of the key-value data may also be obtained from the storage device by calculating the hash value of the prefix. In step 1402, the first storage device is partitioned into cache blocks and at least one shared block. In step 1403, the first key-value data in the key-value data and corresponding to all the layers are respectively stored into the cache blocks corresponding to each of these individual layers. In step 1404, the second key-value data in the key-value data and corresponding to the first layer are stored into the shared block. In step 1405, the second key-value data in the key-value data and corresponding to at least part of the other layers except the first layer are stored into the second storage device. In step 1406, during the inference process performed with respect to the first layer, the first key-value data corresponding to the first layer are read from the cache blocks, and the second key-value data corresponding to the first layer are read from the shared block.

In the above-mentioned data caching method and the host system, the issue of being unable to process more tokens due to insufficient capacity of the storage device can be solved. In addition, the above approach also provides the long-term KV cache, thereby reducing redundant calculations.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

1. A data caching method, adapted to a first storage device and a second storage device and comprising:
inputting a plurality of tokens to a neural network, and obtaining a plurality of key-value data corresponding to a plurality of layers;
partitioning the first storage device into a plurality of cache blocks and at least one shared block;
respectively storing first key-value data of the plurality of key-value data corresponding to the plurality of layers into ones of the plurality of cache blocks corresponding to the plurality of the layers;
storing second key-value data of the plurality of key-value data corresponding to a first layer of the plurality of layers into the at least one shared block;
storing a second key-value data of the plurality of key-value data corresponding to at least one part of other layers of the plurality of layers except the first layer into the second storage device; and
when performing an inference process with respect to the first layer, reading the first key-value data corresponding to the first layer from the plurality of cache blocks, and reading the second key-value data corresponding to the first layer from the at least one shared block.

2. The data caching method according to claim 1, wherein an access speed of the first storage device is greater than an access speed of the second storage device, and a size of the plurality of key-value data is greater than a capacity of the first storage device.

3. The data caching method according to claim 1, further comprising:
after completing the inference process with respect to the first layer, moving a second key-value data corresponding to a new token from the at least one shared block to the second storage device;
reading a second key-value data corresponding to a second layer of the plurality of layers from the second storage device to the at least one shared block; and
when performing an inference process with respect to the second layer, reading the first key-value data corresponding to the second layer from the plurality of cache blocks, and reading the second key-value data corresponding to the second layer from the at least one shared block.

4. The data caching method according to claim 1, further comprising:
obtaining a token length supported by the neural network; and
determining a quantity of the plurality of cache blocks and a quantity of the at least one shared block according to the token length.

5. The data caching method according to claim 4, wherein the step of determining the quantity of the plurality of cache blocks and the quantity of the at least one shared block according to the token length comprises:
obtaining a sum of blocks of the first storage device;
configuring the quantity of the plurality of cache blocks and the quantity of the at least one shared block to be equal to the sum of the blocks;
dividing the token length by a block size to obtain a block length; and
calculating a minimum value of the quantity of the at least one shared block under a condition that a product obtained by multiplying the quantity of the at least one shared block by the quantity of the plurality of layers is added to the quantity of the plurality of cache blocks to obtain a value, and the value is greater than or equal to the block length.

6. The data caching method according to claim 5, further comprising:
gradually increasing the token length as the neural network continues to generate a plurality of output tokens, wherein the block length is greater than the sum of the blocks of the first storage device.

7. The data caching method according to claim 1, further comprising:
generating a plurality of output tokens by the neural network, and connecting the plurality of output tokens to the plurality of tokens to obtain a plurality of historical tokens;
obtaining a first prefix of the plurality of historical tokens;
calculating a first hash value of the first prefix; and
storing the first hash value and a key-value data corresponding to the first prefix into the second storage device.

8. The data caching method according to claim 7, further comprising:
obtaining a second prefix of the plurality of historical tokens, wherein the second prefix covers the first prefix;
calculating a second hash value of the second prefix; and
storing the second hash value and a key-value data corresponding to the second prefix into the second storage device.

9. The data caching method according to claim 7, wherein the step of storing the first hash value and the key-value data corresponding to the first prefix into the second storage device comprises:
determining whether the first hash value hits a first previous hash value of a third storage device, wherein an access speed of the third storage device is greater than an access speed of the second storage device, and the access speed of the third storage device is less than an access speed of the first storage device;
if the first hash value does not hit the first previous hash value, determining whether the third storage device is full;
if the third storage device is not full, writing the first hash value and the key-value data corresponding to the first prefix into the third storage device;
if the third storage device is full, determining whether the second storage device is full;
if the second storage device is full, clearing data in the second storage device;
if the second storage device is not full, selecting a previous key-value data in the third storage device;
determining whether a hash value of the previous key-value data hits a second previous hash value of the second storage device; and
if the hash value of the previous key-value data does not hit the second previous hash value, moving the previous key-value data to the second storage device.

10. The data caching method according to claim 1, wherein the step of obtaining the plurality of key-value data corresponding to the plurality of layers comprises:
obtaining a prefix of the plurality of tokens;
calculating a hash value of the prefix;
determining whether the hash value hits a previous hash value stored into the second storage device; and
if the hash value hits the previous hash value, reading key-value data corresponding to the prefix from the second storage device.

11. The data caching method according to claim 1, wherein:
when performing an inference process with respect to one of the plurality of layers, the plurality of cache blocks store the first key-value data of M layers of the plurality of layers, and the at least one shared block stores second key-value data of N layers of the plurality of layers, wherein the plurality of cache blocks and the at least one shared block are distributed on one memory chip, M and N are positive integers, and M is greater than N.

12. A host system, comprising:
a processor, comprising a first storage device; and
a second storage device,
wherein the processor is electrically connected to the second storage device and configured to execute a plurality of steps:
inputting a plurality of tokens to a neural network, and obtaining a plurality of key-value data corresponding to a plurality of layers;
partitioning the first storage device into a plurality of cache blocks and at least one shared block;
respectively storing first key-value data of the plurality of key-value data corresponding to the plurality of layers into ones of the plurality of cache blocks corresponding to the plurality of layers;
storing second key-value data of the plurality of key-value data corresponding to a first layer of the plurality of layers into the at least one shared block;
storing a second key-value data of the plurality of key-value data corresponding to at least one part of other layers of the plurality of layers except the first layer into the second storage device; and
when performing an inference process with respect to the first layer, reading the first key-value data corresponding to the first layer from the plurality of cache blocks, and reading the second key-value data corresponding to the first layer from the at least one shared block.

13. The host system according to claim 12, wherein an access speed of the first storage device is greater than an access speed of the second storage device, and a size of the plurality of key-value data is greater than a capacity of the first storage device.

14. The host system according to claim 12 wherein the steps further comprise:
after completing the inference process with respect to the first layer, moving a second key-value data corresponding to a new token from the at least one shared block to the second storage device;
reading a second key-value data corresponding to a second layer of the plurality of layers from the second storage device to the at least one shared block; and
when performing an inference process with respect to the second layer, reading the first key-value data corresponding to the second layer from the plurality of cache blocks, and reading the second key-value data corresponding to the second layer from the at least one shared block.

15. The host system according to claim 12, wherein the steps further comprise:
obtaining a token length supported by the neural network; and
determining a quantity of the plurality of cache blocks and a quantity of the at least one shared block according to the token length.

16. The host system according to claim 15, wherein the step of determining the quantity of the plurality of cache blocks and the quantity of the at least one shared block according to the token length comprises:
obtaining a sum of blocks of the first storage device;
configuring the quantity of the plurality of cache blocks and the quantity of the at least one shared block to be equal to the sum of the blocks;
dividing the token length by a block size to obtain a block length; and
calculating a minimum value of the quantity of the at least one shared block under a condition that a product obtained by multiplying the quantity of the at least one shared block by the quantity of the plurality of layers is added to the quantity of the plurality of cache blocks to obtain a value, and the value is greater than or equal to the block length.

17. The host system according to claim 16, wherein the steps further comprise:
gradually increasing the token length as the neural network continues to generate a plurality of output tokens, wherein the block length is greater than the sum of the blocks of the first storage device.

18. The host system according to claim 12, wherein the steps further comprise:
generating a plurality of output tokens by the neural network, and connecting the plurality of output tokens to the plurality of tokens to obtain a plurality of historical tokens;
obtaining a first prefix of the plurality of historical tokens;
calculating a first hash value of the first prefix; and
storing the first hash value and a key-value data corresponding to the first prefix into the second storage device.

19. The host system according to claim 18, wherein the steps further comprise:
obtaining a second prefix of the plurality of historical tokens, wherein the second prefix covers the first prefix;
calculating a second hash value of the second prefix; and
storing the second hash value and a key-value data corresponding to the second prefix into the second storage device.

20. The host system according to claim 18, further comprising a third storage device, wherein the step of storing the first hash value and the key-value data corresponding to the first prefix into the second storage device comprises:
determining whether the first hash value hits a first previous hash value of the third storage device, wherein an access speed of the third storage device is greater than an access speed of the second storage device, and the access speed of the third storage device is less than an access speed of the first storage device;
if the first hash value does not hit the first previous hash value, determining whether the third storage device is full;
if the third storage device is not full, writing the first hash value and the key-value data corresponding to the first prefix into the third storage device;
if the third storage device is full, determining whether the second storage device is full;
if the second storage device is full, clearing data in the second storage device;
if the second storage device is not full, selecting a previous key-value data in the third storage device;
determining whether a hash value of the previous key-value data hits a second previous hash value of the second storage device; and
if the hash value of the previous key-value data does not hit the second previous hash value, moving the previous key-value data to the second storage device.

21. The host system according to claim 12, wherein the step of obtaining the plurality of key-value data corresponding to the plurality of layers comprises:
obtaining a prefix of the plurality of tokens;
calculating a hash value of the prefix;
determining whether the hash value hits a previous hash value stored into the second storage device; and
if the hash value hits the previous hash value, reading key-value data corresponding to the prefix from the second storage device.

22. The host system according to claim 12, wherein the steps further comprise:
when performing an inference process with respect to one of the plurality of layers, the plurality of cache blocks store the first key-value data of M layers of the plurality of layers, and the shared block stores second key-value data of N layers of the plurality of layers, wherein the plurality of cache blocks and the at least one shared block are distributed on one memory chip, M and N are positive integers, and M is greater than N.
